(19) United States
(12) Patent Application Publication
(10) Pub. No.: US 2018/0011829 A1
(43) Pub. Date: Jan. 11, 2018

(54) DATA PROCESSING APPARATUS, SYSTEM, DATA PROCESSING METHOD, AND NON-TRANSITORY COMPUTER READABLE MEDIUM

(71) Applicant: FUJI XEROX CO., LTD., Tokyo (JP)

(72) Inventor: Yoshihito SUEZAWA, Kanagawa (JP)

(73) Assignee: FUJI XEROX CO., LTD., Tokyo (JP)

(21) Appl. No.: 15/449,374

(22) Filed: Mar. 3, 2017

(30) Foreign Application Priority Data
Jul. 6, 2016 (JP) 2016-134402

(51) Int. Cl. G06F 17/24; G06F 17/22

(52) U.S. Cl. CPC G06F 17/241; G06F 17/24; G06F 17/2235; G06F 17/2247

(57) ABSTRACT

A data processing apparatus includes a display controller, a first acquisition unit, a second acquisition unit, and a combining unit. The display controller displays, on a display, an operation screen for a process performed in a different device connected via a network. The first acquisition unit acquires an image of the operation screen. The second acquisition unit acquires plural pieces of information received on the operation screen. The combining unit combines an annotation image that represents each of the acquired pieces of information with the image that represents the operation screen.

### CROSS-REFERENCE TO RELATED APPLICATIONS

This application is based on and claims priority under 35 USC 119 from Japanese Patent Application No. 2016-134402 filed Jul. 6, 2016.

### BACKGROUND

### Technical Field

The present invention relates to a data processing apparatus, a system, a data processing method, and a non-transitory computer readable medium.

### SUMMARY

According to an aspect of the present invention, there is provided a data processing apparatus including: a display controller that displays, on a display, an operation screen for a process performed in a different device connected via a network; a first acquisition unit that acquires an image of the operation screen; a second acquisition unit that acquires plural pieces of information received on the operation screen; and a combining unit that combines an annotation image that represents each of the acquired pieces of information with the image that represents the operation screen.

### BRIEF DESCRIPTION OF THE DRAWINGS

An exemplary embodiment of the present invention will be described in detail based on the following figures, wherein:

FIG. 1 illustrates the configuration of a system;

FIG. 2 illustrates the functional configuration of a client device;

FIG. 3 illustrates the hardware configuration of the client device;

FIG. 4 illustrates an example of the software configuration of the client device;

FIG. 5 illustrates an example of the software configuration of a storage server;

FIG. 6 illustrates an example of the correlation between know-how document IDs and work folder IDs;

FIG. 7 illustrates an example of the correlation between coordination system IDs and the know-how document IDs;

FIG. 8 is a flowchart illustrating the flow of a work folder generation process;

FIG. 9 is a flowchart illustrating the flow of a know-how document generation process;

FIG. 10 illustrates an example of a system operation screen;

FIG. 11 illustrates an example of a screenshot to which a link annotation has been pasted;

FIG. 12 illustrates an example of a screenshot to which a text annotation has been pasted;

FIG. 13 is a flowchart illustrating the flow of a binding process;

FIG. 14 is a flowchart illustrating the flow of a know-how document synchronization process;

FIG. 15 is a flowchart illustrating the flow of the know-how document synchronization process; and

FIG. 16 illustrates an example of a screenshot to which a link annotation has been pasted.

### DETAILED DESCRIPTION

[1] Configuration

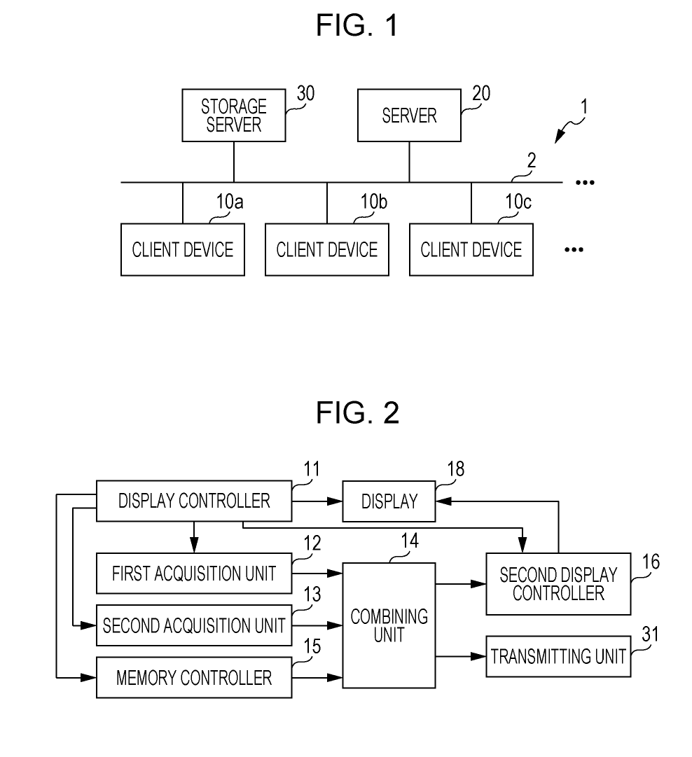

FIG. 1 is a block diagram illustrating the configuration of a system 1 according to an exemplary embodiment. The system 1 includes client devices 10a, 10b, 10c, . . . , a server 20, and a storage server 30. The client devices 10a, 10b, 10c, . . . are devices, e.g. personal computers, to be operated by users. In the case where it is not necessary to differentiate the client devices 10a, 10b, 10c, . . . from each other, such devices are referred to as a “client device 10”. The server 20 provides a variety of services such as electronic payment and project progress management. Although one server 20 is illustrated in FIG. 1, plural servers may be used to provide the services. In the following description, the services provided by the server 20 are called “coordination systems”. The storage server 30 is a server that provides a data saving service, and has a storage that stores a variety of setting files and document files. The server 20 and the storage server 30 may be so-called cloud servers. A communication line 2 includes at least one of the Internet, a mobile communication network, and a telephone line, for example. The client device 10 and the server 20 are connected to the communication line 2.

In the exemplary embodiment, the storage server 30 stores document files to be used as work manuals when a user works using an operation screen of a coordination system. The document files describe an example of data to be input to the operation screen of the coordination system and an example of operation procedures. In the following description, for the convenience of description, the document files to be used as work manuals are called “know-how documents”.

The know-how documents are distributed to the client device 10 in response to a request or the like from the client device 10. The distributed know-how documents and the know-how documents stored in the storage server 30 are subjected to a synchronization process to be discussed later at a timing determined in advance.

FIG. 2 illustrates an example of the functional configuration of the client device 10 (an example of the data processing apparatus) and the storage server 30. The client device 10 includes a display controller 11, a first acquisition unit 12, a second acquisition unit 13, a combining unit 14, a memory controller 15, and a second display controller 16. The display controller 11 displays, on a display 18, an operation screen for a process performed in a different device connected via a network. The first acquisition unit 12 acquires an image of the operation screen. The second acquisition unit 13 acquires plural pieces of information received on the operation screen. The combining unit 14 combines an annotation image that represents each of the acquired pieces of information with the image that represents the operation screen.

The memory controller 15 stores a history of screen transitions of the operation screen in a memory. The second display controller 16 displays, on the display 18, a page that includes an image whose degree of similarity to the operation screen being displayed on the display 18 meets a condition determined in advance, among plural images of the operation screen included in a document file, when the document file that includes the plural images is opened. A transmitting unit 31 of the storage server 30 transmits a document file, to which an image of the operation screen has been added, to a device to which an identifier corresponding to the document file has been assigned, among other devices connected via a network.

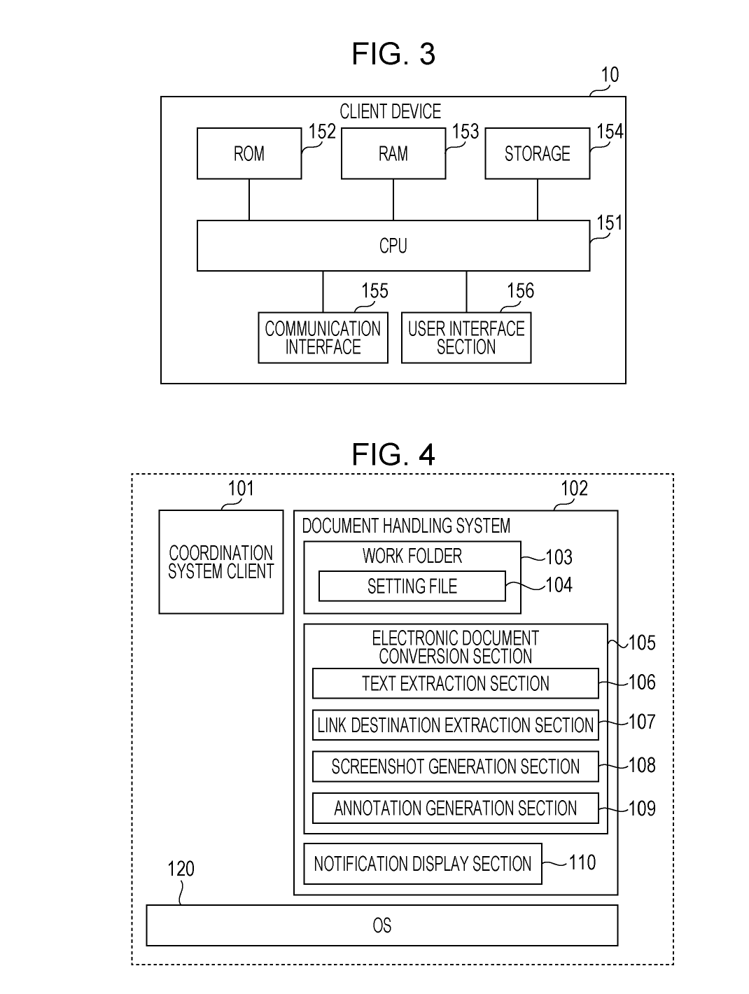

FIG. 3 illustrates the hardware configuration of the client device 10. The client device 10 includes a central processing unit (CPU) 151, a read-only memory (ROM) 152, a random-access memory (RAM) 153, a storage 154, a communication interface 155, and a user interface section 156. The CPU 151 is a control device (processor) that controls various portions of the client device 10. The ROM 152 is a non-volatile storage device that stores programs and data. The RAM 153 is a volatile principal storage device that functions as a work area when the CPU 151 executes a program. The storage 154 is a non-volatile auxiliary storage device that stores programs and data. The communication interface 155 is an interface for communication via the communication line 2. In this example, in particular, the communication interface 155 is an interface for communication with the server 20. The user interface section 156 includes a touch screen and keys, for example.

In this example, the functions illustrated in FIG. 2 are implemented by the CPU 151 by executing the programs stored in the storage 154. The CPU 151 which executes the programs is an example of the display controller 11, the first acquisition unit 12, the second acquisition unit 13, the combining unit 14, the memory controller 15, and the second display controller 16. The user interface section 156 is an example of the display 18. The CPU of the storage server 30 is an example of the transmitting unit according to the present invention.

FIG. 4 illustrates an example of the software configuration of the client device 10. In the drawing, a coordination system client 101 and a document handling system 102 are applications installed in advance in the client device 10, and operate on an operating system (OS) 120. The coordination system client 101 is an application that displays an operation screen of the coordination system (an operation screen for a process performed in the server 20) on the user interface section 156, and is a browser, for example. The document handling system 102 is an application that manages files and folders. The document handling system 102 includes a work folder 103, an electronic document conversion section 105, and a notification display section 110. The work folder 103 is a folder that stores files and tools. The work folder 103 stores files and folders, and stores tools that perform a process (e.g. a file format conversion process and a character recognition process) on the files and the folders. The work folder 103 stores a setting file 104. The setting file 104 is a file that includes set values related to the work folder 103. The setting file 104 includes a Universally Unique Identifier (UUID), a Uniform Resource Locator (URL), and a path of the work folder 103, a coordination system ID for identification of a coordination system to be started from the work folder 103, and so forth. The setting file 104 is described in Extensible Markup Language (XML), for example.

The electronic document conversion section 105 is a component that performs a process of converting a screenshot of a screen of the coordination system into an electronic document. The electronic document conversion section 105 includes a text extraction section 106, a link destination extraction section 107, a screenshot generation section 108, and an annotation generation section 109. The text extraction section 106 extracts a text input to the operation screen of the coordination system. The link destination extraction section 107 performs a process of extracting a link destination (such as a URL) for the screen of the coordination system. The screenshot generation section 108 generates a screenshot of the operation screen of the coordination system. The annotation generation section 109 generates an annotation on an electronic document. The notification display section 110 has a function of notifying the user, in the case where a know-how document in the work folder 103 has been updated, that the know-how document has been updated through display on the user interface section 156.

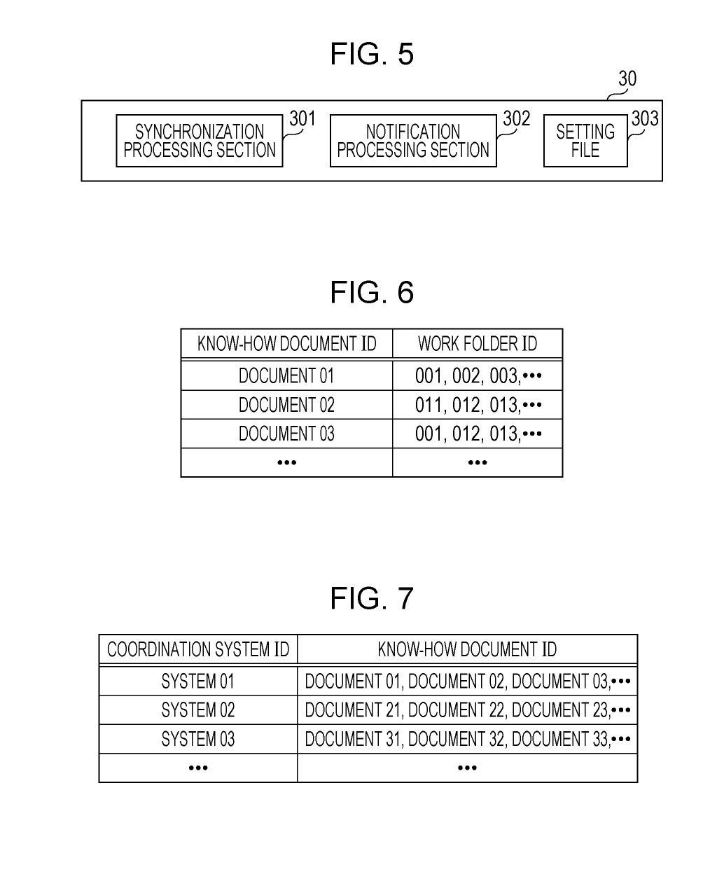

FIG. 5 illustrates an example of the software configuration of the storage server 30. In the drawing, a setting file 303 is a file that includes set values related to the files and the data stored in the storage server 30. The setting file 303 is described in XML, for example. In the exemplary embodiment, the setting file 303 includes information that indicates the time and date of update of the know-how documents, the correlation between know-how document IDs for identification of the know-how documents and work folder IDs for identification of the work folders, and the correlation between coordination system IDs and the know-how document IDs.

FIG. 6 illustrates an example of the correlation between the know-how document IDs and the work folder IDs. In the setting file 303, the know-how documents ID for identification of the know-how documents and the work folder IDs for identification of the work folders in which the know-how documents are stored are linked to each other. The example illustrated in FIG. 6 indicates that a know-how document to which a know-how document ID of “document 01” has been assigned is stored in work folders to which work folder IDs of “001”, “002”, and “003” have been assigned.

FIG. 7 illustrates an example of the correlation between the coordination system IDs and the know-how document IDs. In the setting file 303, the coordination system IDs for identification of the coordination systems and the know-how documents that serve as guidance on the coordination systems are linked to each other. Besides, the setting file 303 also describes the correlation between the work folder IDs and the coordination system IDs etc.

A synchronization processing section 301 is a component that performs a synchronization process for a know-how document in accordance with the content of the description in the setting file 303. In the exemplary embodiment, when a request for a synchronization process is received from the client device 10, the synchronization processing section 301 specifies a work folder ID linked to the know-how document as the target of the synchronization process, and transmits the know-how document as the target of the synchronization process to a client device 10 that stores a work folder indicated by the specified work folder ID. A notification processing section 302 is a component that performs a notification process for the work folder 103 as the notification destination described in the setting file 303.

[2] Operation

The user utilizes the coordination system using the client device 10. First, the user performs an operation for starting the document handling system 102 using the user interface section 156. The OS 120 implemented by the CPU 151 starts the document handling system 102 in response to information output from the user interface section 156. The document handling system 102 causes the user interface section 156 to display an operation screen of the document handling system 102. On the operation screen of the document handling system 102, the user first performs an operation for creating a work folder. This operation may be an operation of depressing a “create new work folder” button on the operation screen of the document handling system 102, for example.

[2-1] Operation to Generate Work Folder

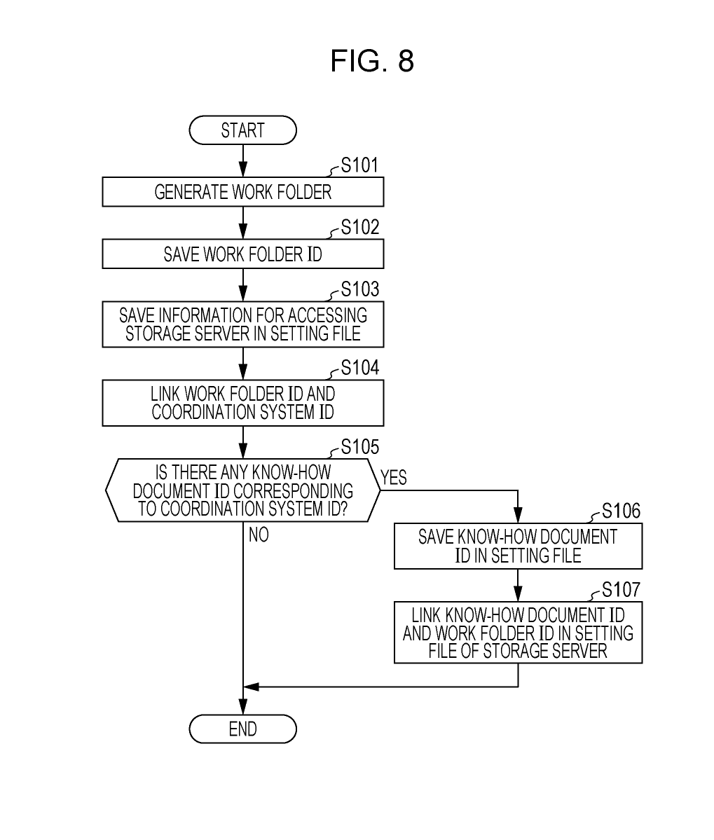

FIG. 8 is a flowchart illustrating the flow of a work folder generation process performed by the document handling system 102. The process illustrated in FIG. 8 is started with the user's operation for creating a work folder as an impetus. First, in step S101, the document handling system 102 generates a new work folder and a new setting file corresponding to the work folder, and stores the generated folder and file in a storage area of the storage 154 determined in advance. In step S102, the document handling system 102 issues a work folder ID for identification of the generated work folder, and describes the issued work folder ID in the setting file 104 in the work folder 103 to save the work folder ID in the setting file 104.

In step S103, the document handling system 102 acquires information that indicates the location of storage of the setting file 303 from the storage server 30, and describes the acquired information in the setting file 104 in the work folder 103 to save the acquired information.

In step S104, the document handling system 102 requests the storage server 30 to link the work folder ID of the generated work folder to the coordination system ID of the coordination system which has been started. The storage server 30 links the work folder ID and the coordination system ID to each other in the setting file 303 in accordance with the request from the document handling system 102.

In step S105, the document handling system 102 determines whether or not there is any know-how document ID linked to the coordination system ID. In the case where it is determined that there is no such know-how document ID, the document handling system ends the process. In the case where it is determined that there is any such know-how document ID, on the other hand, the document handling system 102 proceeds to the process in step S106.

In step S106, the document handling system 102 saves the know-how document ID by adding the know-how document ID to the setting file 104 in the work folder 103. In step S107, the document handling system 102 requests the storage server 30 to link the saved know-how document ID and the work folder ID for identification of a work folder in the device itself to each other. The storage server 30 links the know-how document ID and the work folder ID to each other by adding the pair of the know-how document ID and the work folder ID to the setting file 303 in accordance with the request from the client device 10.

[2-2] Operation to Generate Know-how Document

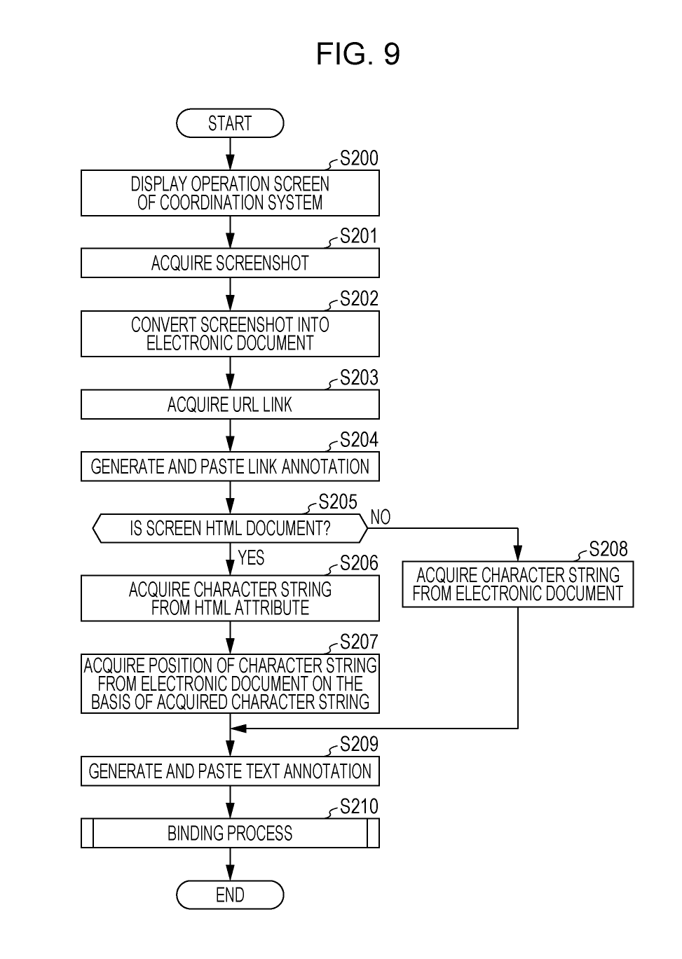

FIG. 9 is a flowchart illustrating the flow of a know-how document generation process. The operation screen of the document handling system 102 includes an image (e.g. an icon) for accessing the operation screen of the coordination system, and the process illustrated in FIG. 9 is started with the user's operation for starting the coordination system by selecting the image as an impetus. In step S200, the document handling system 102 displays the operation screen of the coordination system (an operation screen for a process performed in the storage server 30). Specifically, in the exemplary embodiment, when an operation for starting the coordination system is performed by the user, the document handling system 102 requests the OS 120 to start the coordination system client 101 and access to the coordination system. The OS 120 starts the coordination system client 101 in accordance with the request from the document handling system 102. The coordination system client 101 accesses the address of the coordination system, and displays the operation screen of the coordination system on the user interface section 156. In the following description, for the convenience of description, the operation screen of the coordination system is called a “system operation screen”.

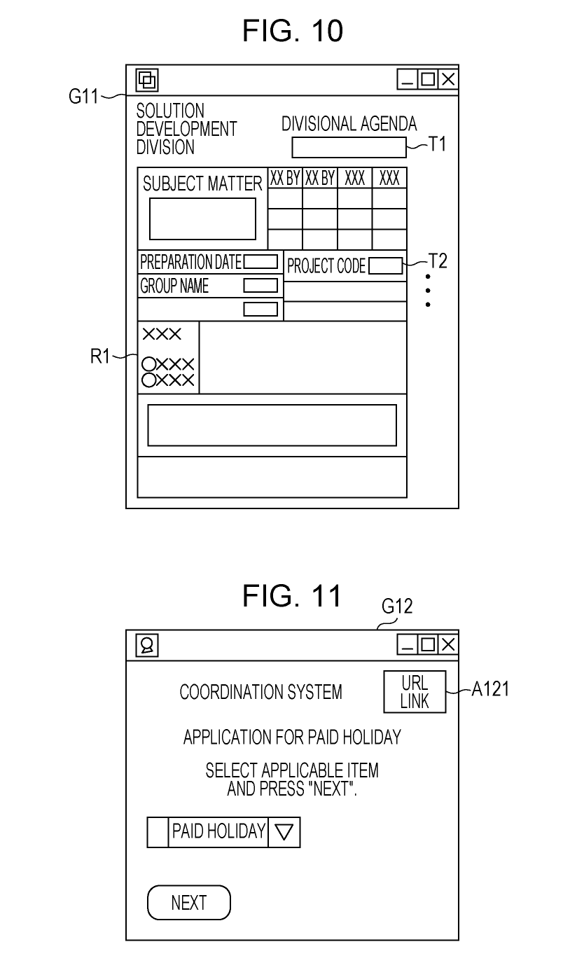

FIG. 10 illustrates an example of the system operation screen. A system operation screen G11 illustrated in FIG. 10 includes text boxes T1, T2, . . . for the user to input a text, radio buttons R1 for the user to select one of plural items, and so forth. The user inputs a text and selects an item on the system operation screen using the user interface section 156. In the exemplary embodiment, each time the system operation screen is updated because of text input, item selection, a screen transition, or the like, the document handling system 102 is notified of such an update by way of the OS 120.

FIG. 9 is described again. When the user performs an operation for generating a know-how document, the document handling system 102 acquires a screenshot which is an image of the system operation screen (hereinafter referred to simply as a “screenshot”) in step S201. In the exemplary embodiment, the document handling system 102 acquires, from the OS 120, information related to the display area of the operation screen of the coordination system client 101 that the document handling system 102 itself has started, and requests the OS 120 to acquire a screenshot of the display area of the system operation screen in accordance with the acquired information. The OS 120 generates a screenshot of the system screen in accordance with the request from the document handling system 102, and delivers the screenshot to the document handling system 102.

In step S202, the document handling system 102 converts the generated screenshot into an electronic document by generating a know-how document (file) and pasting the screenshot to the know-how document. In step S203, the document handling system 102 acquires an address (such as a URL) corresponding to the system operation screen. In step S204, the document handling system 20 generates a link annotation which is an annotation for jumping to a link destination, and combines the generated link annotation with the screenshot. This link is a URL of the screen of the coordination system, or a command path for opening the screen of the coordination system.

FIG. 11 illustrates an example of the screenshot composed with the link annotation. In a screenshot G12 illustrated in FIG. 11, when a link annotation A121 is depressed by the user, a system operation screen acquired from a URL corresponding to the link annotation is displayed on the user interface section 156.

FIG. 9 is described again. In step S205, the document handling system 102 determines whether or not the system operation screen is a HyperText Markup Language (HTML) document. In the case where the system operation screen is an HTML document, the document handling system 102 proceeds to the process in step S206. In the case where the system operation screen is not an HTML document, on the other hand, the document handling system 102 proceeds to the process in step S208.

In step S206, the document handling system 102 acquires character strings from an HTML attribute to acquire plural pieces of information received on the system operation screen. Examples of this HTML attribute include the type=“text” attribute of an <input> tag and the attribute of a <textarea> tag. In step S207, the document handling system 102 acquires a position on the system operation screen at which each of the character strings acquired in step S206 has been received for each of the character strings on the basis of the character strings. When the process in step S207 is finished, the document handling system 102 proceeds to the process in step S209.

In the case where the system operation screen is not an HTML document, the document handling system 102 acquires character strings from the electronic document to acquire plural pieces of information received on the system operation screen in step S208. In an example of a method of acquiring character strings, the document handling system 102 may perform a character recognition process on the electronic document to acquire character strings surrounded by a rectangular figure in a shape determined in advance, for example. In another example, the document handling system 102 may acquire character strings in a font size or a font color determined in advance, for example. The document handling system 102 acquires a position on the system operation screen at which each of the acquired pieces of information has been received for each of the pieces of information. When the process in step S208 is finished, the document handling system 102 proceeds to the process in step S209.

In step S209, the document handling system 102 generates a text annotation which is an annotation that indicates the character strings acquired in step S206 or step S208, and pastes the generated text annotation to the electronic document. The text annotation is an example of an annotation image that represents the information acquired in step S206 or step S208. That is, the document handling system 102 performs a process of combining the text annotation which represents each of the acquired pieces of information with the screenshot of the system operation screen. In this event, the document handling system 102 combines the generated text annotation at a position in the screenshot corresponding to the position at which each of the pieces of information has been acquired. In the exemplary embodiment, the document handling system 102 combines the text annotation with the screenshot such that the display position of each of the pieces of information and the display position of the text annotation overlap each other.

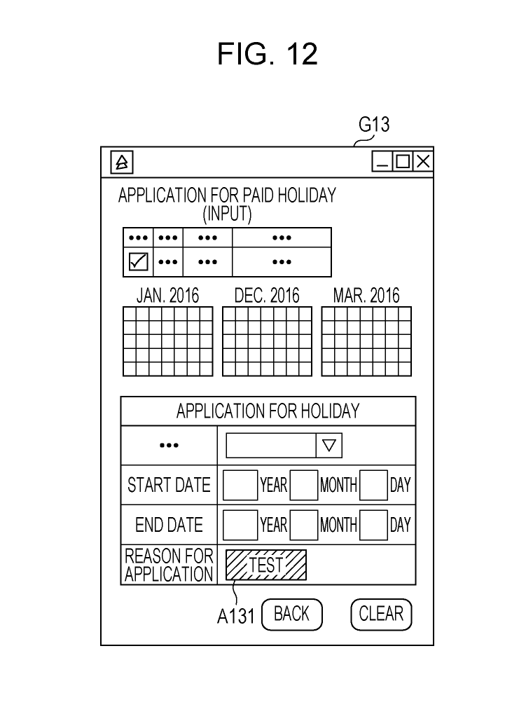

FIG. 12 illustrates an example of the screenshot provided with the text annotation. In the example illustrated in FIG. 12, a text annotation A131 that represents a character string “text” is pasted at a position in a screenshot G13 overlapping a character string “text”. Through the process described above, the screenshot composed with the annotation image (link annotation or text annotation) is included in the know-how document created for each URL of the system operation screen.

FIG. 9 is described again. In step S210, the document handling system 102 performs a process (binding process) of compiling electronic documents including screenshots of the system operation screen in a folder or a single archive file called a “binder” for each of the types of the coordination systems.

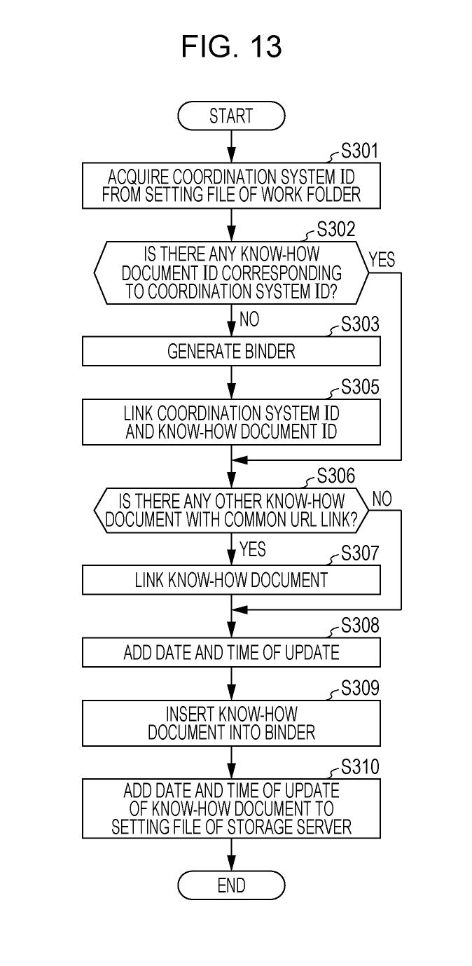

FIG. 13 is a flowchart illustrating the flow of the binding process performed in step S210 of FIG. 9. In step S301, the document handling system 102 acquires a coordination system ID from the setting file 104 of the work folder 103. In step S302, the document handling system 102 determines whether or not there is any other know-how document ID corresponding to the acquired coordination system ID. In the case where it is determined that there is no other such know-how document ID, the document handling system 102 proceeds to the process in step S303. In the case where it is determined that there is any other such know-how document ID, on the other hand, the document handling system 102 skips the processes in steps S303 to S305, and proceeds to the process in step S306.

In step S303, the document handling system 102 generates a binder for the coordination system corresponding to the know-how document to be processed. In step S305, the document handling system 102 issues a know-how document ID of the know-how document to be processed, and links the issued know-how document ID and the coordination system ID to each other in the setting file 104 in the work folder 103.

In step S306, the document handling system 102 determines whether or not there is any other know-how document that includes a screenshot corresponding to the URL of a screenshot included in the know-how document to be processed, that is, any know-how document with a common URL link. In the case where it is determined that there is any other know-how document, the document handling system 102 proceeds to the process in step S307. In the case where it is determined that there is no other know-how document, on the other hand, the document handling system 102 skips the process in step S307, and proceeds to the process in step S308.

In step S307, the document handling system 102 performs a process of linking plural know-how documents with a common URL link to each other into a single know-how document. That is, in the exemplary embodiment, in the case where there are plural screenshots for one system operation screen, the plural screenshots are compiled into a single know-how document.

In step S308, the document handling system 102 provides the know-how document with information that indicates the date and time of update. In step S309, the document handling system 102 inserts the know-how document into the binder. In step S310, the document handling system 102 requests the storage server 30 to update the date and time of update of the know-how document registered in the setting file 303. The storage server 30 updates the date and time of update of the know-how document in accordance with the request from the client device 10.

[2-2] Operation to Synchronize Know-How Document

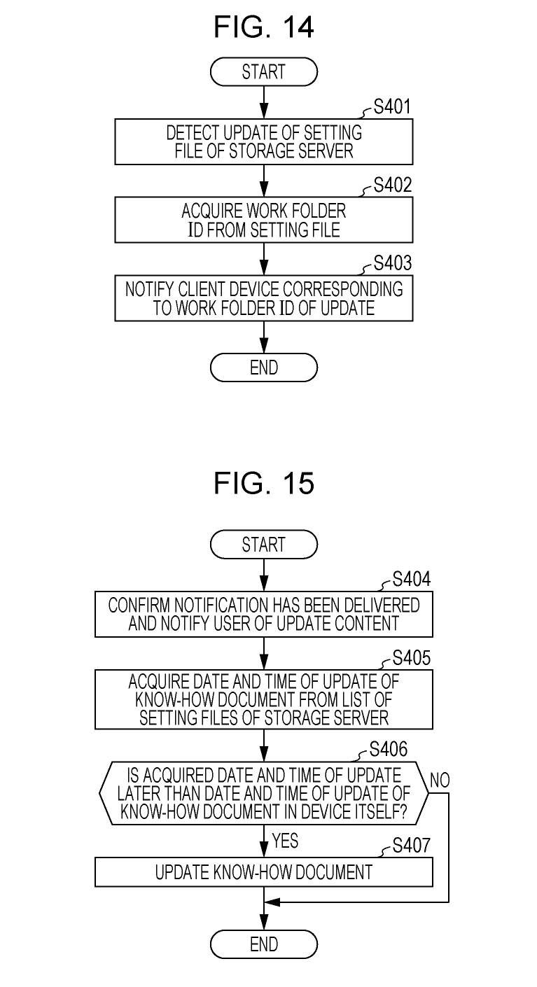

FIG. 14 is a flowchart illustrating the flow of a know-how document update notification process performed by the storage server 30. As discussed above, the storage server 30 updates information that indicates the date and time of update of the know-how document in accordance with the request from the client device 10. In step S401, the storage server 30 detects an update of the setting file 303. In step S402, the storage server 30 acquires a work folder ID correlated with a document ID of a know-how document, an update of which has been detected. In step S403, the storage server 30 notified the client device 10 corresponding to the acquired work folder ID of a fact that the know-how document has been updated. That is, the storage server 30 specifies a work folder ID corresponding to the know-how document ID, and notifies the client device 10 corresponding to the specified work folder ID of a fact that the know-how document has been updated.

FIG. 15 is a flowchart illustrating the flow of a know-how document synchronization process performed by the client device which has been notified of the update. The process illustrated in FIG. 15 is started with a notification of the update of the know-how document from the storage server 30 as an impetus. In step S404, the document handling system 102 confirms that a notification has been delivered, and notifies the user of the content of the update. This notification may be made by causing the user interface section 156 to display the content of the update, for example.

In step S405, the document handling system 102 acquires the date and time of update of the know-how document from the setting file in the storage server 30 by making an inquiry of the storage server 30 about the date and time of update of the know-how document. In step S406, the document handling system 102 determines whether or not the acquired date and time of update is later than the date and time of update of the know-how document in the work folder 103 of the device itself. In the case where it is determined that the acquired date and time of update is the later, the document handling system 102 proceeds to the process in step S407. In the case where it is determined that the acquired date and time of update is the earlier, the document handling system 102 skips the process in step S407, and ends the process.

In step S407, the document handling system 102 acquires the know-how document from the storage server 30, and updates the know-how document stored in the work folder 103 using the acquired know-how document.

[2-4] Operation to Display Know-How Document

Next, operation for a case where the know-how document is referenced by the user will be described. When an operation of opening the work folder is performed by the user, the document handling system 102 causes the user interface section 156 to display the operation screen of the document handling system 102, and causes the user interface section 156 to display the know-how document.

The user works with reference to the screenshot of the system operation screen included in the know-how document. A text input to the system operation screen in the previous work is displayed as a text annotation on the displayed screenshot. In order to access the coordination system, it is only necessary for the user to click a URL link (link annotation) of the know-how document. In the exemplary embodiment, in the case where there are plural screenshots for one system operation screen, the plural screenshots are compiled into a single know-how document.

[3] Modifications

The exemplary embodiment discussed above is merely exemplary of the present invention, and may be modified as follows. The exemplary embodiment discussed above and the modifications described below may be implemented in combination as necessary.

(1) In the exemplary embodiment discussed above, the know-how document generation process is performed with the user's operation for generating a know-how document as an impetus. However, the timing to perform the know-how document generation process is not limited thereto. For example, the know-how document generation process or updating process may be performed regularly at each timing determined in advance. Alternatively, the know-how document generation process or updating process may be performed each time the system operation screen is updated because of text input, item selection, a screen transition, or the like on the system operation screen, for example. Alternatively, the know-how document generation process or updating process may be performed each time the system operation screen transitions, for example. Alternatively, the know-how document generation process or updating process may be performed at the timing when the system operation screen is closed, for example.

(2) In the exemplary embodiment discussed above, the know-how document synchronization process (process illustrated in FIG. 14) is started with a notification of the update of the know-how document from the storage server 30 as an impetus. The timing to perform the know-how document synchronization process is not limited thereto. For example, the document handling system 102 may make an inquiry of the storage server 30 regularly at each timing determined in advance about whether or not to update the know-how document.

(3) In the exemplary embodiment discussed above, the document handling system 102 may record the order of transition of the system operation screen, and paste information that indicates the transition destination to the screenshots as an annotation. In this example, the document handling system 102 stores a history of screen transitions of the system operation screen according to an operation by the user when creating a know-how document. The document handling system 102 provides each of the screenshots of the system operation screen with information (e.g. a link annotation) that indicates the system operation screen as the transition destination in accordance with the stored history.

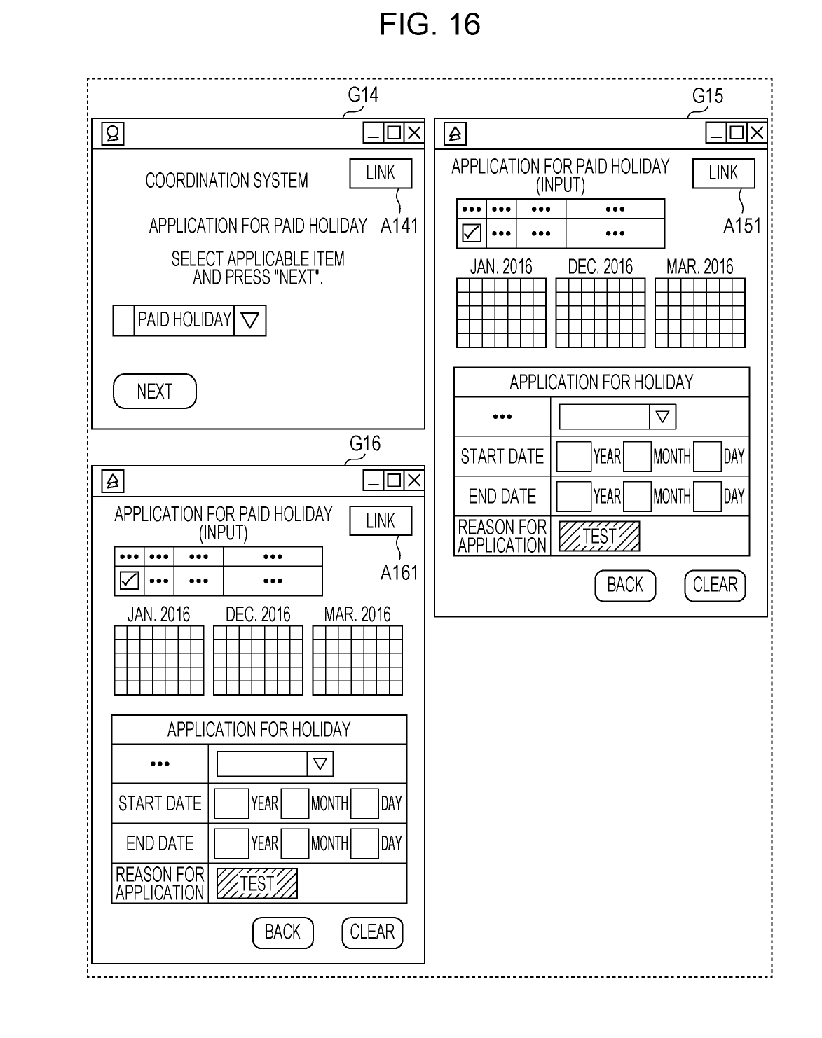

FIG. 16 illustrates an example of the screenshot composed with the link annotation. In the example illustrated in FIG. 16, a link annotation A141 for jumping to the page of a screenshot G15 as the next transition destination is composed with a screenshot G14. In addition, a link annotation A151 for jumping to the page of a screenshot G16 as the next transition destination is composed with the screenshot G15. In addition, a link annotation A161 for jumping to the page of a screenshot as the next transition destination is composed with the screenshot G16.

In this case, the screen transition of the system operation screen is reproduced when the know-how document is displayed.

(4) In the exemplary embodiment discussed above, the document handling system 102 may display, on the user interface section 156, a page that includes a screenshot whose degree of similarity to the system operation screen being displayed on the user interface section 156 meets a condition determined in advance, among the plural screenshots included in the know-how document, when the system operation screen is referenced by the user. In this case, the document handling system 102 may select and display a screenshot with the highest degree of similarity, or may select and display a screenshot with the degree of similarity equal to or more than a threshold determined in advance, for example, among the plural screenshots included in the know-how document.

Work related to the coordination system differs in accordance with the division to which the user belongs or the attribute of the user. Therefore, the electronic document desired to be referenced during work differs among users. For example, in an attendance management system, operation days may differ among business institutions, and even the content to be displayed in one operation screen may differ among business institutions. Meanwhile, in a divisional discussion system, for example, the content to be displayed may differ in accordance with the type of the division and the name of the budget. In this aspect, when the system operation screen is referenced by the user, a page of the know-how document that is similar to the system operation screen is displayed.

(5) In the exemplary embodiment discussed above, the document handling system 102 displays the know-how document, together with the operation screen of the document handling system 102, on the user interface section 156 when an operation of opening the work folder is performed by the user. However, the timing to display the know-how document is not limited thereto. For example, the document handling system 102 may display the know-how document on the user interface section 156 in the case where an operation for opening the know-how document is performed by the user. Alternatively, the document handling system 102 may display the know-how document, together with the system operation screen, on the user interface section 156 in the case where an operation for opening the system operation screen is performed.

(6) In the exemplary embodiment discussed above, a service is provided by a single server 20. However, a service may be provided through cooperation of plural servers.

(7) In the exemplary embodiment discussed above, a text annotation or a link annotation is provided as the annotation image which represents information received on the system operation screen. However, the annotation image is not limited thereto. For example, a balloon image, an exclamation mark, or a combination of such an image or a mark and a character string may be used as the annotation image.

(8) In the exemplary embodiment discussed above, the document handling system 102 combines the annotation image which represents information received on the system operation screen at a position in the screenshot at which the information has been acquired. However, the position at which the annotation image is composed is not limited thereto. The annotation image may be composed at a position that is different from the position in the screenshot corresponding to the position at which the information has been acquired on the system operation screen. Alternatively, a balloon image that indicates the position in the screenshot at which the information has been acquired may be composed at a position that is different from the position in the screenshot at which the information has been acquired.

(9) In the exemplary embodiment discussed above, the programs executed by the CPU 151 of the client device 10 and the programs executed by the CPU of the storage server 30 may be downloaded via a communication line such as the Internet. Alternatively, such programs may be provided as stored in a computer-readable storage medium such as a magnetic storage medium (such as a magnetic tape and a magnetic disk), an optical storage medium (such as an optical disc), a magneto-optical storage medium, and a semiconductor memory.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing apparatus comprising:
a display controller that displays, on a display, an operation screen for a process performed in a different device connected via a network;
a first acquisition unit that acquires an image of the operation screen;
a second acquisition unit that acquires a plurality of pieces of information received on the operation screen; and
a combining unit that combines an annotation image that represents each of the acquired pieces of information with the image that represents the operation screen.

2. The data processing apparatus according to claim 1,
wherein the second acquisition unit acquires, for each of the pieces of information, a position on the operation screen at which the piece of information has been received, and
the combining unit combines the annotation image at a position in the image corresponding to the position at which the information has been acquired.

3. The data processing apparatus according to claim 1,
wherein the combining unit provides the image with an address corresponding to the operation screen, and compiles images provided with a common address into a single document file.

4. The data processing apparatus according to claim 1, further comprising:
a memory controller that stores a history of screen transitions of the operation screen in a memory,
wherein the combining unit provides each of images of the operation screen with information that indicates an operation screen as a transition destination in accordance with the history.

5. The data processing apparatus according to claim 1,
wherein the combining unit combines a document file that includes a plurality of images, and
the data processing apparatus further includes a second display controller that displays, on the display, a page that includes an image whose degree of similarity to the operation screen being displayed on the display meets a condition determined in advance, among the plurality of images included in the document file.

6. A system comprising:
a data processing apparatus; and
a server,
wherein the data processing apparatus includes
a display controller that displays, on a display, an operation screen for a process performed in a different device connected via a network,
a first acquisition unit that acquires an image of the operation screen,
a second acquisition unit that acquires a plurality of pieces of information received on the operation screen, and
a combining unit that combines an annotation image that represents each of the acquired pieces of information with the image that represents the operation screen, and that adds the image with which the annotation image has been composed to a document file, and
the server includes a transmitting unit that transmits the document file, to which the image has been added, to a device to which an identifier corresponding to the document file has been assigned, among different devices connected via the network.

7. A data processing method comprising:
displaying, on a display, an operation screen for a process performed in a different device connected via a network;
acquiring an image of the operation screen;
acquiring a plurality of pieces of information received on the operation screen; and
combining an annotation image that represents each of the acquired pieces of information with the image that represents the operation screen.

8. A non-transitory computer readable medium storing a program causing a computer to execute a process comprising:
displaying, on a display, an operation screen for a process performed in a different device connected via a network;
acquiring an image of the operation screen;
acquiring a plurality of pieces of information received on the operation screen; and
combining an annotation image that represents each of the acquired pieces of information with the image that represents the operation screen.
